(19) United States
(12) Patent Application Publication
(10) Pub. No.: US 2008/0156740 A1
(43) Pub. Date: Jul. 3, 2008

(54) METHOD FOR PRODUCING A STABLE OXIDIZING BIOCIDE

(76) Inventors: Amit Gupta, Aurora, IL (US); Manian Ramesh, Barrington Hill, IL (US); Randall Elliott, Naperville, IL (US)

Correspondence Address: NALCO COMPANY, 1601 W. DIEHL ROAD, NAPERVILLE, IL, 60563-1198, US

(21) Appl. No.: 11/618,227

(22) Filed: Dec. 29, 2006

(51) Int. Cl. C02F 1/76

(52) U.S. Cl. 210/756; 210/754

(57) ABSTRACT

The invention relates to a production method for producing stable chloramine. The method allows for the production of stable chloramine with the use of concentrated Chlorine source and concentrated amine source and agitation during production. The method produces a chloramine that has a pH of at least 5 with a most preferred pH of at least 7 or greater.

### COPYRIGHT NOTICE

A portion of the disclosure of this patent document contains or may contain copyright protected material. The copyright owner has no objection to the photocopy reproduction by anyone of the patent document or the patent disclosure in exactly the form it appears in the Patent and Trademark Office patent file or records, but otherwise reserves all copyright rights whatsoever.

### TECHNICAL FIELD

This invention relates to the production of stable chloramine for use as a biocidal composition. The invention shows the method for production of chloramine in a stable form that allows for the production, storage and transportation of chloramine. The invention demonstrates the method of producing a stable and functional chloramine, which allows for the use of chloramines in water treatment systems, and a wide variety of other treatment systems, as biocidal composition without its rapid degradation.

### BACKGROUND

The invention described here pertains to the production of a biofouling control agent. The basis for the invention is the composition of the reactants and the conditions for production using concentrated reactants to convert two liquid solutions from their native chemical form to another with altered biocidal properties.

Throughout the world, there are many different types of industrial water systems. Industrial water systems exist so that necessary chemical, mechanical and biological processes can be conducted to reach the desired outcome. Fouling can occur even in industrial water systems treated with the best water treatment programs currently available. For purposes of this patent application “fouling” is defined as “the deposition of any organic or inorganic material on a surface”.

If these industrial water systems are not treated for microbial fouling control, then they will become heavily fouled. Fouling has a negative impact on the industrial water system. For example, severe mineral scale (inorganic material) can buildup on the water contact surfaces and anywhere there is scale, there is an ideal environment for the growth of microorganisms.

Fouling occurs by a variety of mechanisms including deposition of air-borne and water-borne and water-formed contaminants, water stagnation, process leaks, and other factors. If allowed to progress, the system can suffer from decreased operational efficiency, premature equipment failure, loss in productivity, loss in product quality, and increased health-related risks associated with microbial fouling.

Fouling can also occur due to microbiological contamination. Sources of microbial contamination in industrial water systems are numerous and may include, but are not limited to, air-borne contamination, water make-up, process leaks and improperly cleaned equipment. These microorganisms can rapidly establish microbial communities on any wetted or semi-wetted surface of the water system. Once these microbial populations are present in the bulk water more than 99% of the microbes present in the water will be present on the surface in the form of biofilms.

Exopolymeric substance secreted from the microorganisms aid in the formation of biofilms as the microbial communities develop on the surface. These biofilms are complex ecosystems that establish a means for concentrating nutrients and offer protection for growth. Biofilms can accelerate scale, corrosion, and other fouling processes. Not only do biofilms contribute to reduction of system efficiencies, but they also provide an excellent environment for microbial proliferation that can include pathogenic bacteria. It is therefore important that biofilms and other fouling processes be reduced to the greatest extent possible to maximize process efficiency and minimize the health-related risks from water-borne pathogens.

Several factors contribute to the problem of biological fouling and govern its extent. Water temperature; water pH; organic and inorganic nutrients, growth conditions such as aerobic or anaerobic conditions, and in some cases the presence or absence of sunlight, etc. can play an important role. These factors also help in deciding what types of microorganisms might be present in the water system.

As described earlier, biological fouling can cause unwanted process interferences and therefore must be controlled. Many different approaches are utilized for the control of biological fouling in industrial processes. The most commonly used method is the application of biocidal compounds to the process waters. The biocides applied may be oxidizing or non-oxidizing in nature. Due to several different factors such as economics and environmental concerns, the oxidizing biocides are preferred. Oxidizing biocides such as chlorine gas, hypochlorous acid, bromine derived biocides, and other oxidizing biocides are widely used in the treatment of industrial water systems.

One factor in establishing the efficacy of oxidizing biocides is the presence of components within the water matrix that would constitute a “chlorine demand” or oxidizing biocide demand. “Chlorine demand” is defined as the quantity of chlorine that is reduced or otherwise transformed to inert forms of chlorine by substances in the water. Chlorine-consuming substances include, but are not limited to, microorganisms, organic molecules, ammonia and amino derivatives; sulfides, cyanides, oxidizable cations, pulp lignins, starch, sugars, oil, water treatment additives like scale and corrosion inhibitors, etc. Microbial growth in the water and in biofilms contributes to the chlorine demand of the water and to the chlorine demand of the system to be treated. Conventional oxidizing biocides were found to be ineffective in waters containing a high chlorine demand, including heavy slimes. Non-oxidizing biocides are usually recommended for such waters.

Chloramines are effective and are typically used in conditions where a high demand for oxidizing biocides such as chlorine exists or under conditions that benefit from the persistence of an ‘oxidizing’ biocide. Domestic water systems are increasingly being treated with chloramines. Chloramines are generally formed when free chlorine reacts with ammonia present or added to the waters. Many different methods for production of chloramines have been documented. Certain key parameters of the reaction between the chlorine and the nitrogen source determine the stability, and efficacy of the produced biocidal compound. The previously described methods have relied on either the pre-formation of dilute solutions of the reactants followed by their combination to produce a solution of chloramines. The reactants are an amine source in the form of an ammonium salt (sulfate, bromide, or chloride) and a Cl-donor (chlorine donor) in the form of gas or combined with alkali earth metal (Na or Ca). Also, the described methods have relied on controlling the pH of the reaction mix by the addition of a reactant at a high pH or by the separate addition of a caustic solution. The disinfectant thus produced must be immediately fed into the system being treated since the disinfectant degrades rapidly. The disinfectant solution is generated outside the system being treated and then fed into the aqueous system for treatment. In previously described methods of production for treatment of liquids to control biological fouling, a significant problem occurred in that the active biocidal ingredient was unstable chemically and rapidly decomposed with a resulting fast drop in pH. This rapid deterioration of the biocidal ingredient resulted in a loss in efficacy. It was also observed that the pH of the active biocidal ingredient was never >8.0 due to the rapid decomposition of the biocidal component (referenced in U.S. Pat. No. 5,976,386).

### SUMMARY

The current invention describes the following key aspects:
1. A composition of the reactants for production of a “more stable” disinfectant solution,
2. Conditions for the production of a “more stable” form of the biocidal component, and
3. A process for the production of the disinfectant.

### DETAILED DESCRIPTION

The invention relates to a method for producing a stable chloramine wherein a concentrated chlorine source is combined with a concentrated amine source and is agitated to produce a stable chloramine with a pH above 5. The chlorine source of the invention contains an alkali earth metal where the preferred source of the chlorine is sodium hypochlorite or calcium hypochlorite and the amine source is preferably ammonium sulfate (N₄)₂SO₄, or ammonium hydroxide NH₄OH.

The method of the invention includes a reaction means where the reaction of the Chlorine source and the amine source occurs to form the chloramine. The reaction means is a liquid that is preferably water. The product of the invention is stable chloramine.

The invention details a method for producing a stable chloramine wherein a concentrated Chlorine source is combined with a concentrated amine source with a reaction means and is agitated to produce a stable chloramine with a pH of 7 or above.

### EXAMPLES

The foregoing may be better understood by reference to the following example, which is intended to illustrate methods for carrying out the invention and is not intended to limit the scope of the invention.

### Example 1

In an experiment to understand the production and stability of the chloramine solution produced, fresh solutions of hypochlorite, (NH₄)₂SO₄, and NH₄OH were prepared and used for the production of chloramine. The prepared hypochlorite solution was tested separately and was found to contain ˜110 ppm as free Cl₂, as expected from dilutions. The amount of chloramine produced was evaluated by measuring the Free Cl₂ and Total Cl₂ of the product. Results from the experiment showed that 100% conversion to chloramine (Total Cl₂) was observed. In addition, the pH of the product produced with (NH₄)₂SO₄, and NH₄OH remained above 7.

The chloramine solution produced was kept in the dark and reanalyzed after 1 day. Free Cl₂ and Total Cl₂ was measured again to understand the stability of the chloramine solution, produced and maintained in a closed space of a 50 ml tube. The data was compared to the production time data and loss in Total Cl₂ level was a measure of the loss of chloramine from the solution. The chloramine products produced with amine derived from (NH₄)₂SO₄, or NH₄OH showed only slight degradation, 7.7% and 5.9%, respectively, after 1 day. As an observation, the chloramine solution produced with amine derived from Ammonium Bromide (NH₄Br) showed more than 90% loss/degradation after 1 day.

It should be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method for producing a stable chloramine wherein a concentrated Chlorine source is combined with a concentrated amine source and is agitated to produce a stable chloramine with a pH above 5.

2. The method of claim 1 wherein the Chlorine source contains an alkali earth metal.

3. The method of claim 1 wherein the amine source is ammonium sulfate.

4. The method of claim 1 wherein the amine source is ammonium hydroxide.

5. The method of claim 1 also including a reaction means where the reaction of the Chlorine source and the amine source occurs to form the chloramine.

6. The method of claim 5 wherein the reaction means is a liquid.

7. The method of claim 5 wherein the reaction means is water.

8. The method of claim 1 wherein the stable chloramine has a pH of 7 or greater.

9. The method of claim 2 wherein the Chlorine source is sodium hypochlorite or calcium hypochlorite.

10. A method for producing a stable chloramine wherein a concentrated Chlorine source is combined with a concentrated amine source with a reaction means and is agitated to produce a stable chloramine with a pH of 7 or greater.

11. The method of claim 10 wherein the Chlorine source contains an alkali earth metal.

12. The method of claim 11 wherein the Chlorine source is sodium hypochlorite or calcium hypochlorite.

13. The method of claim 10 wherein the amine source is ammonium sulfate.

14. The method of claim 10 wherein the amine source is ammonium hydroxide.

15. The method of claim 10 wherein the reaction means is a liquid.

16. The method of claim 15 wherein the reaction means is water.
